(19) United States
(12) Patent Application Publication
(10) Pub. No.: US 2019/0052539 A1
(43) Pub. Date: Feb. 14, 2019

(54) PROGRAMMABLE TESTER FOR MASTER-SLAVE DEVICE NETWORKS

(71) Applicant: Intel Corporation, Santa Clara, CA (US)

(72) Inventors: Lakshminarayana Pappu, Folsom, CA (US); Amit Kumar Srivastava, Folsom, CA (US)

(21) Appl. No.: 16/021,404

(22) Filed: Jun. 28, 2018

(51) Int. Cl. H04L 12/24; G06F 13/40

(52) U.S. Cl. CPC H04L 41/14; G06F 13/4068

(57) ABSTRACT

Embodiments include apparatuses, methods, and systems for testing that include a programmable tester coupled to a master-slave device network having a master device and at least one slave device. The programmable tester is to receive a configuration mode from a host to test a function of a selected device of the master device or the at least one slave device. The configuration mode is to indicate that the programmable tester is to be configured to operate in a slave mode or in a master mode. The programmable tester is further configured according to the configuration mode, to send test data to test the function of the selected device, determine a test result based on response data by the selected device to the test data, and indicate whether the selected device is in a faulty state with respect to the function. Other embodiments may also be described and claimed.

### FIELD

Embodiments of the present invention relate generally to the technical fields of computing, and more particularly to testing of master-slave device networks, including their devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

The advance of computing technology has brought many kinds of computing devices for various applications, such as sensors, Internet of Things devices, and more. Multiple devices may be coupled together by device networks to perform complicated functions, in particular, in the form of a master-slave device network. Sometimes, a master device of the master-slave device network may be implemented on a system on chip (SoC). It is desirable to be able to test and ensure the multiple devices coupled to the master-device device network are functioning properly as designed. Often times, aggressive time to market posts a big challenge for testing all the various devices that could be coupled to the master-slave device network.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example computing system including a tester coupled to a master-slave device network and a host to test the master-slave device network, in accordance with various embodiments.

FIG. 2 illustrates another example computing system including a tester coupled to a master-slave device network and a host to test the master-slave device network, in accordance with various embodiments.

FIGS. 3(a)-3(c) illustrate another example computing system including an I3C network tester coupled to an I3C network and a host to test the I3C network, in accordance with various embodiments.

FIG. 4 illustrates a sequence diagram of a process performed by a tester coupled to a master-slave device network to test the master-slave network, in accordance with various embodiments.

FIG. 5 illustrates an example computer device suitable for use to practice various aspects of the present disclosure, in accordance with various embodiments.

FIG. 6 illustrates a storage medium having instructions for practicing methods described with references to FIGS. 1-5, in accordance with various embodiments.

### DETAILED DESCRIPTION

Multiple computing devices, such as sensors, Internet of Things devices, may be coupled together by a device network to perform various functions. A device network may be a master-slave device network having a master device, e.g., a master controller, and at least one slave device. With the rapid advances of semiconductor technology, the master device of a master-slave device network may be implemented by a system on chip (SoC). With the multitude of devices, sensors, IOT devices and so forth, that could be coupled to the master-slave device network, it is challenging to be able to exhaustively test all devices that could be coupled to the master-slave device network in different instantiations or usages of the SoC.

Embodiments herein may present a tester to test a master-slave device network, including its master device and the one or more slave devices. The tester is programmable/configurable to operate in a slave mode or in a master mode according to a configuration mode received from a host. The tester may operate in a slave mode to test a master device of the master-slave device network, or operate in a master mode to test a slave device of the master-slave device network. The tester may be used in the field by original equipment manufacturer (OEM), or in the factory according to high volume manufacturing (HVM) test flow. For example, a tester may be used to ensure the reliability of an I3C network in the field. An OEM can identify and disable failing sensor devices of an I3C network using the tester. The tester may be used to test any 3rd party sensor device for an I3C network.

In embodiments, an apparatus for testing includes a programmable tester. The programmable tester is coupled to a master-slave device network having a master device and at least one slave device. The programmable tester includes interface circuitry and logic circuitry. The interface circuitry of the programmable tester is to receive a configuration mode from a host to test a function of a selected device of the master device or the at least one slave device of the master-slave device network. The configuration mode is to indicate that the programmable tester is to be configured to operate in a slave mode or in a master mode. The logic circuitry is to configure the programmable tester according to the configuration mode on receipt of the configuration mode. In addition, the logic circuitry is to send test data to test the function of the selected device, determine a test result based on response data by the selected device to the test data, and indicate whether the selected device is in a faulty state with respect to the function based at least in part on the test result.

In embodiments, an apparatus for computing includes a master-slave device network and a tester coupled to the master-slave device network. The master-slave device network includes a master controller and a computer bus to couple the master controller to one or more slave devices. The tester is to test a function of a selected one of the master controller or the one or more slave devices. In detail, the tester is to send test data to the master controller directly when the function being tested is of the master controller. Additionally and alternatively, the tester is to send test data to the one slave device, via the master controller, when the function being tested is of the one slave device. In addition, the tester is to receive response data from the master controller or the one slave device in response to the test data. The tester is further to evaluate the response data to determine a test result to indicate whether the master controller or the one slave device is in a faulty state with respect to the function.

In embodiments, an apparatus for computing includes an I3C network, an I3C network tester coupled to the I3C network, and a processor coupled to the I3C network and the I3C network tester. The I3C network includes an I3C master and a 2-wire bus to couple the I3C master to one or more sensor devices. The processor is to determine selected ones of the I3C master and the one or more sensor devices to be tested for a set of protocols of the I3C network. The processor is further to transmit to the I3C network tester identifications of the selected ones of the I3C master and the one or more sensor devices to be tested for the set of protocols. In addition, the processor is to transmit to the I3C network tester test data or instructions to generate test data to test the selected ones of the I3C master and the one or more sensor devices for the set of protocols. Afterwards, the processor is to receive indications from the I3C network tester on whether one or more of the selected the ones of the I3C master and the one or more sensor devices are in a faulty state with respect to the set of protocols.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrases “A/B,” “A or B,” and “A and/or B” mean (A), (B), or (A and B). For the purposes of the present disclosure, the phrases “A, B, or C” and “A, B, and/or C” mean (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As discussed herein, the term “module” may be used to refer to one or more physical or logical components or elements of a system. In some embodiments, a module may be a distinct circuit, while in other embodiments a module may include a plurality of circuits.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

As used herein, the term “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources. Examples of “computer devices”, “computer systems”, etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management Systems (EEMSs), electronic/engine control units (ECUs), vehicle-embedded computer devices (VECDs), autonomous or semi-autonomous driving vehicle (hereinafter, simply ADV) systems, in-vehicle navigation systems, electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

As used herein, the term “network element” may be considered synonymous to and/or referred to as a networked computer, networking hardware, network equipment, router, switch, hub, bridge, radio network controller, radio access network device, gateway, server, and/or any other like device. The term “network element” may describe a physical computing device of a wired or wireless communication network and be configured to host a virtual machine. Furthermore, the term “network element” may describe equipment that provides radio baseband functions for data and/or voice connectivity between a network and one or more users. The term “network element” may be considered synonymous to and/or referred to as a “base station.” As used herein, the term “base station” may be considered synonymous to and/or referred to as a node B, an enhanced or eNB, gNB, base transceiver station (BTS), access point (AP), roadside unit (RSU), etc., and may describe equipment that provides the radio baseband functions for data and/or voice connectivity between a network and one or more users. As used herein, the terms “vehicle-to-vehicle” and “V2V” may refer to any communication involving a vehicle as a source or destination of a message. Additionally, the terms “vehicle-to-vehicle” and “V2V” as used herein may also encompass or be equivalent to vehicle-to-infrastructure (V2I) communications, vehicle-to-network (V2N) communications, vehicle-to-pedestrian (V2P) communications, or V2X communications.

As used herein, the term “channel” may refer to any transmission medium, either tangible or intangible, which is used to communicate data or a data stream. The term “channel” may be synonymous with and/or equivalent to “physical channel,” “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information.

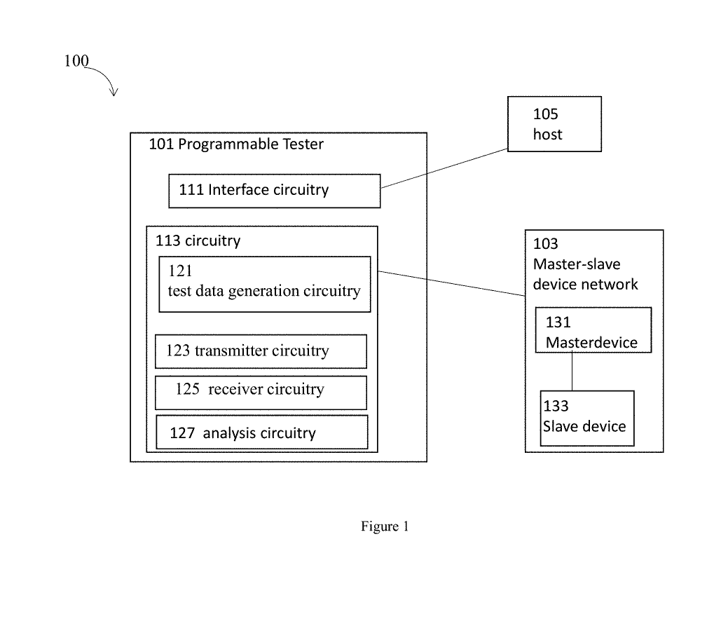

FIG. 1 illustrates an example computing system 100 including a tester 101 coupled to a master-slave device network 103 and a host 105 to test a selected device of a master device 131 or a slave device 133 of the master-slave device network 103, in accordance with various embodiments. For clarity, features of a tester, a master-slave device network, a host, a master device or a slave device of the master-slave device network, may be described below as examples for understanding an example tester, a master-slave device network, a host, a master device or a slave device of the master-slave device network. It is to be understood that there may be more or fewer components within a tester, a master-slave device network, a host, a master device or a slave device of the master-slave device network. Further, it is to be understood that one or more of the components within a tester, a master-slave device network, a host, a master device or a slave device of the master-slave device network, may include additional and/or varying features from the description below, and may include any device that one having ordinary skill in the art would consider and/or refer to as a tester, a master-slave device network, a host, a master device or a slave device of the master-slave device network.

In embodiments, the computing system 100 includes the tester 101 coupled to the master-slave device network 103 and the host 105 to test the master-slave device network 103, including e.g., a selected device of the master device 131 or the slave device 133 of the master-slave device network 103. The tester 101 includes interface circuitry 111, and logic circuitry 113. For the illustrated embodiments, the logic circuitry 113 includes test data generation circuitry 121, transmitter circuitry 123, receiver circuitry 125, and analysis circuitry 127. The master-slave device network 103 includes the master device 131, and one or more slave devices, e.g., the slave device 133.

In embodiments, the interface circuitry 111 is to receive a configuration mode from the host 105 to test the master-slave device network 103, e.g., a function of a selected device of the master device 131, the at least one slave device 133 of the master-slave device network 103, or combinations thereof. The configuration mode is to indicate that the tester 101 is to be configured to operate in a slave mode or in a master mode. The logic circuitry 113 is to configure the tester 101 according to the configuration mode on receipt of the configuration mode. In addition, the logic circuitry 113 is to send test data to test the function of the selected device or devices. In detail, the test data generation circuitry 121 of the logic circuitry 113 is to generate at least a portion of the test data being sent to test the function of the selected device or devices. The transmitter circuitry 123 is to send the test data to the master device 131 or the slave device 133. The receiver circuitry 125 is to receive response data from the device to be tested in response to the test data. The analysis circuitry 127 is to determine a test result based on response data received by the receiver circuitry 125. Furthermore, the logic circuitry 113 is to indicate whether the selected device is in a faulty state with respect to the function based at least in part on the test result. For example, the logic circuitry 113 is to indicate to the host 105 whether the selected device is in the faulty state with respect to the function, via the interface circuitry 111.

In embodiments, the tester 101 is configured to operate in slave mode according to the configuration mode, when the selected device to be tested is the master device 131. The transmitter circuitry 123 of the logic circuitry 113 is to send the test data to the master device 131, the receiver circuitry 125 of the logic circuitry 113 is to receive response data from the selected master device 131 in response to the test data, and the analysis circuitry 127 of the logic circuitry 113 is to evaluate the response data to determine the test result.

In embodiments, the tester 101 is configured to operate in master mode according to the configuration mode, when the selected device to be tested is a slave device, e.g., the slave device 133. The transmitter circuitry 123 of the logic circuitry 113 is to send the test data to the selected slave device 133 through the master device 131 of the master-slave device network 103. In embodiments, the transmitter circuitry 123 is to send the test data to the selected slave device 133 of the master-slave device network 103 by broadcasting. Alternatively, the transmitter circuitry 123 is to transmit the test data to the selected slave device 133 with an address of the selected slave device 133 to particularize the recipient of the test data, and track the test data sent to the selected slave device 133.

In embodiments, the logic circuitry 113 is further to configure the master device 131 of the master-slave device network 103 to operate in a slave mode, for the receiver circuitry 125 to receive the response data through the master device 131. The receiver circuitry 125 of the logic circuitry 113 is to receive through the master device 131 the response data from the selected slave device 133 in response to the test data. The analysis circuitry 127 of the logic circuitry 113 is to evaluate the response data to determine the test result. In addition, the logic circuitry 113 is further to disable the selected slave device 133 when the test result indicates the selected slave device 133 is in the faulty state with respect to the function.

In embodiments, the tester 101 may have bare minimum functionality for testing and debugging purposes, without performing other system functions designed for the device network. For example, the tester 101 may be equipped with just enough functionality to be able to send and receive protocol adherent transactions to test the function of the device or devices to be tested.

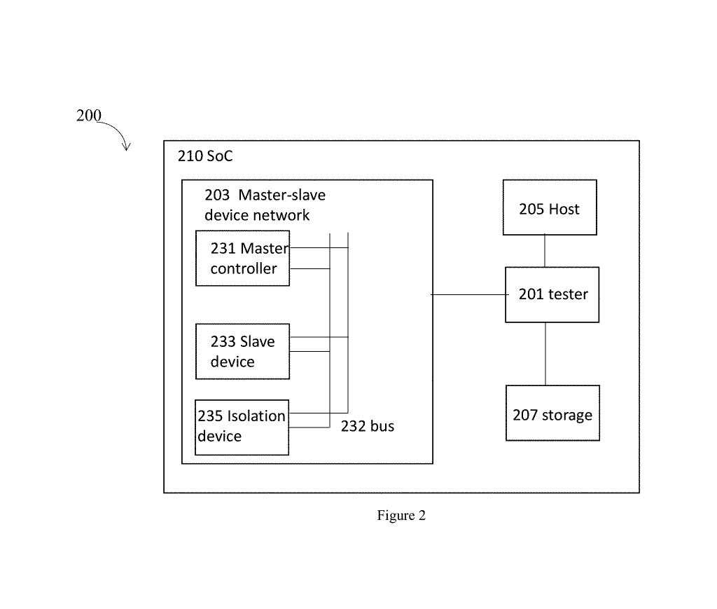

FIG. 2 illustrates an example computing system 200 including a tester 201 coupled to a master-slave device network 203 and a host 205 to test the master-slave device network 203, e.g., a selected device of a master controller 231 or a slave device 233 of the master-slave device network 203, in accordance with various embodiments. In embodiments, the computing system 200, the tester 201, the master-slave device network 203, the host 205, the master controller 231, or the slave device 233 may be examples of computing system 100, the tester 101, the master-slave device network 103, the host 105, the master device 131, or the slave device 133, respectively, as shown in FIG. 1.

In embodiments, the computing system 200, including the tester 201, the master-slave device network 203, the host 205, the master controller 231, and a storage 207 may be in a SoC. Different slave devices 233 may be attached to the master-slave device network 203 for different adoptions and usages of different instances of SoC 210. The storage 207, for the illustrated embodiments, is used to store the test result by the tester 201, and the storage 207 is accessible by the host 205 for the test result. In some embodiments, the storage 207 may be secured registers that may be accessible through the sideband network for OEMs and HVM teams for faulty device isolation.

In embodiments, the tester 201 may be similar to the tester 101 that includes interface circuitry, test data generation circuitry, transmitter circuitry, receiver circuitry, and analysis circuitry, not shown. Hence, the tester 201 is configurable as either to operate in a slave mode or in a master mode. The master-slave device network 203 includes the master controller 231, one or more slave devices, e.g., the slave device 233, an isolation device 235, coupled by a computer bus 232. In some embodiments, the computer bus 232 includes a two-wire bidirectional serial bus controlled by the master controller 231. The two-wire bidirectional serial bus includes a wire designated as serial data (SDA) and a wire designated as serial clock (SCL). The isolation device 235 is to isolate the computer bus 232 to prevent noise from the computer bus 232. The isolation device 235 is in an ON state when the tester 201 is configured to operate in a slave mode to test the function of the master controller 231.

In embodiments, the master-slave device network 203 may be an I3C network, and the tester 201 is to operate in a data rate of 10 Mbps, a data rate of 26.7 Mbps, or other operational speed, e.g., single data rate (SDR), high data rate (HDR), as specified by the I3C network standard or other device network standard.

In embodiments, the tester 201 is to test the master-slave device network 203 e.g., a function of a selected one of the master controller 231 or the one or more slave devices, e.g., the slave device 233. The function of the device to be tested may include a function of the device to act as the master controller, a function of the device to act as a slave device for the master controller. In addition, the function of the device to be tested may be network functions applied to the device. For example, the function to be tested may be arbitration between two slave devices coupled to the master controller 231. Additionally and alternatively, the function to be tested may be an operating frequency of the device of the master-slave device network. Furthermore, the function to be tested may be a traffic pattern of the device. In some embodiments, the function to be tested may be a short or an open of the computer bus coupling the master controller 231 to one or more slave devices, e.g., the slave device 233. Many techniques for testing a short or an open of a computer bus may be performed. For example, the devices in the master-slave device network 203 may be tested one by one to identify those devices that can function correctly, and those devices that completely fail the test, to diagnosis a location of a short or an open point of the computer bus 232.

The tester 201 may perform testing operations similar to the operations performed by the tester 101 in FIG. 1. When a function to be tested is of the master controller 231, the tester 201 is to send the test data to the master controller 231 directly, receive response data from the master controller 231, and evaluate the response data to determine a test result to indicate whether the master controller 231 is in a faulty state with respect to the function to be tested.

On the other hand, when the function to be tested is of the one slave device, e.g., the slave device 233, the tester 201 is to send the test data via the master controller 231 to the one slave device 233, receive response data from the one slave device 233 in response to the test data, and evaluate the response data to determine a test result to indicate whether the one slave device 233 is in a faulty state with respect to the function. As such, the master controller 231 may only pass through the test data to the one slave device 233 and the response data from the one slave device 233, without performing any additional functions. The tester 201 can extract the data directly from the one slave device 233 without the help of the master controller 231 on the network, by hooking to the master-slave device network 203.

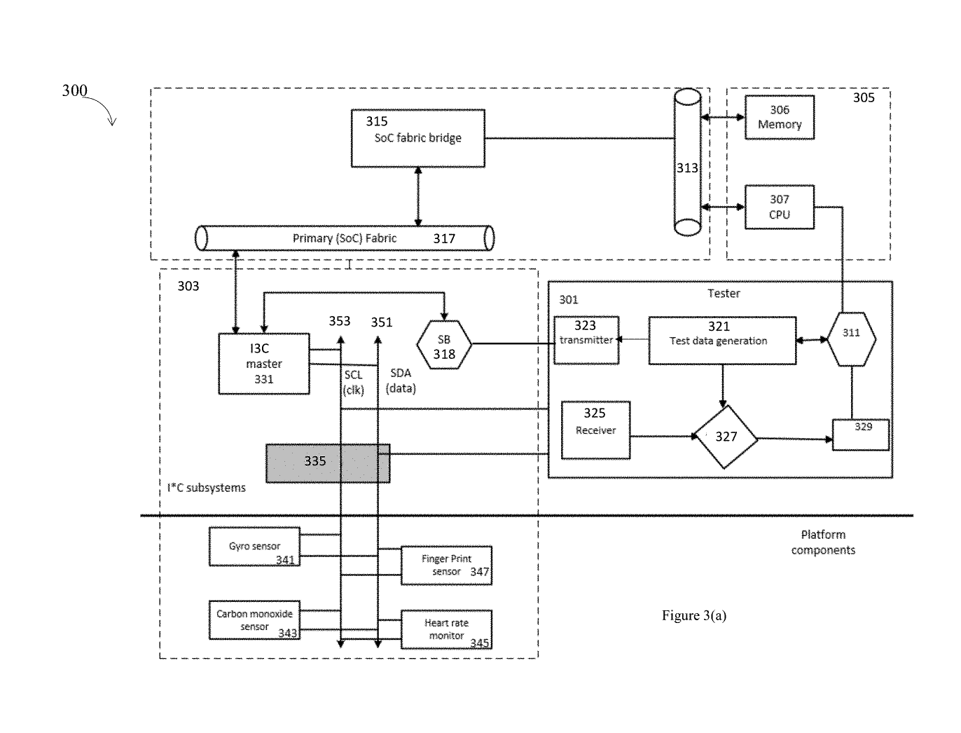

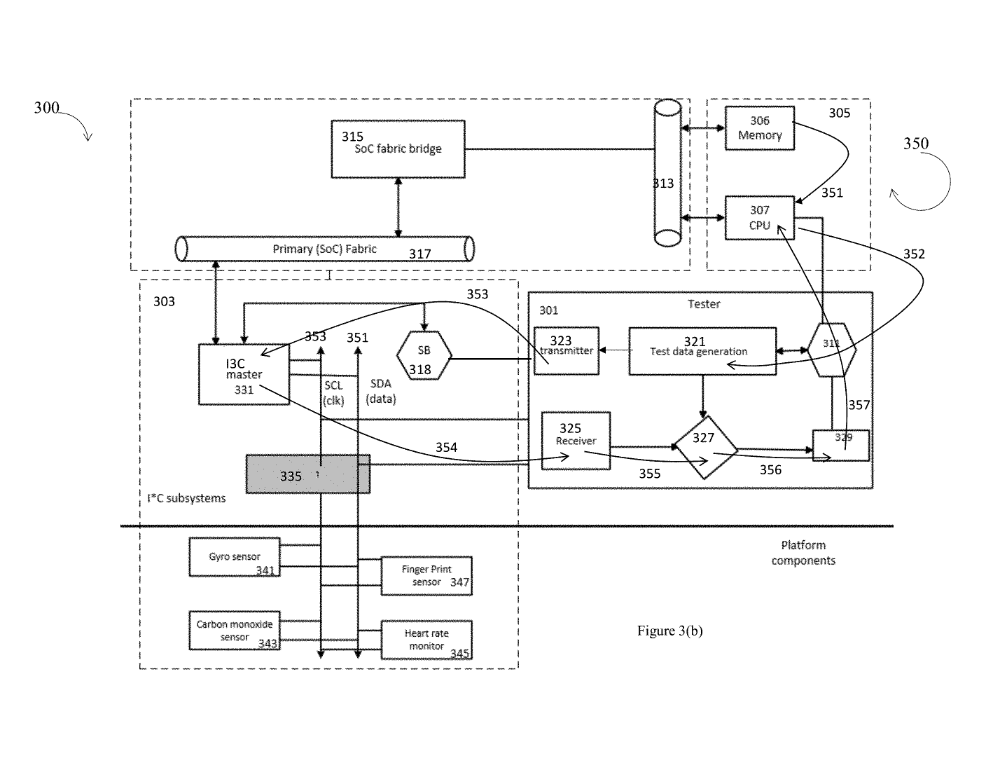

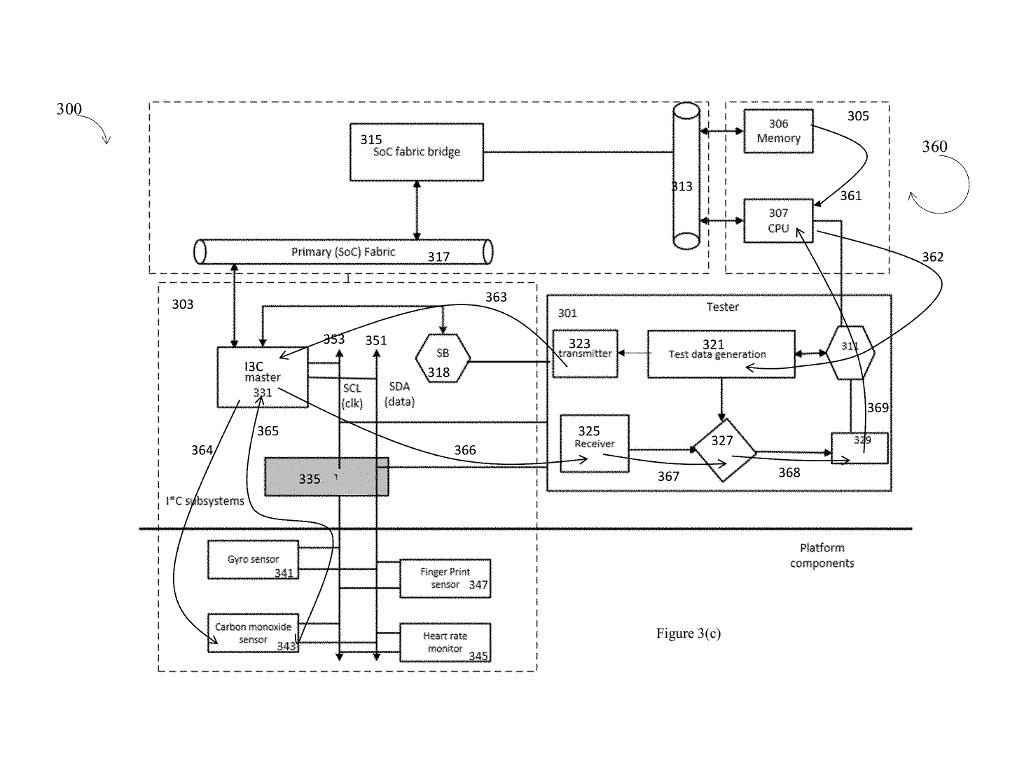

FIGS. 3(a)-3(c) illustrate an example computing system 300 including an I3C network tester 301 coupled to an I3C network 303 and a host 305 to test a selected device of an I3C master 331 or a sensor device, e.g., a sensor device 341, a sensor device 343, a sensor device 345, or a sensor device 347, in accordance with various embodiments. In embodiments, the computing system 300, the I3C network tester 301, the I3C network 303, the host 305, the I3C master 331, the sensor device 341, the sensor device 343, the sensor device 345, or the sensor device 347, may be examples of the computing system 200, the tester 201, the master-slave device network 203, the host 205, the master controller 231, or the slave device 233, respectively, as shown in FIG. 2. Similarly, the computing system 300, the I3C network tester 301, the I3C network 303, the host 305, the I3C master 331, the sensor device 341, the sensor device 343, the sensor device 345, or the sensor device 347, may be examples of the computing system 100, the tester 101, the master-slave device network 103, the host 105, the master device 131, or the slave device 133, respectively, as shown in FIG. 1. The use of an I3C network is for example only, and is not limiting. For example, the I3C network 303 may be an I2C network, any other earlier or later generation sensor network, or any other master-slave device network performing similar functions.

In embodiments, the computing system 300, except for the slave devices 341-347, may be a SoC and may include the I3C network tester 301 coupled to the I3C network 303 and the host 305 to test a selected device of the I3C network 303. Most of the time, a SoC may only include the I3C network tester 301 coupled to the I3C network 303 and the host 305, without the slave devices. Different slave devices may be attached to the SoC at different usage of different instantiations. In some other embodiments, one or more devices of the slave devices 341-347, e.g., popular slave devices that virtually everyone uses, may be included in a SoC together with the I3C network tester 301 coupled to the I3C network 303 and the host 305.

In embodiments, the I3C network tester 301 includes interface circuitry 311, test data generation circuitry 321, transmitter circuitry 323, receiver circuitry 325, analysis circuitry 327, and a storage 329. The host 305 includes a center processing unit (CPU) 307 and a system memory 306. In some embodiments, the host 305 may be referred to as a processor as well. The I3C network 303 includes the I3C master 331, an isolation device 335, interface circuitry 318, a sensor device, e.g., the sensor device 341, the sensor device 343, the sensor device 345, or the sensor device 347. A sensor device, e.g., the sensor device 341, the sensor device 343, the sensor device 345, or the sensor device 347 may be a platform component provided by a 3^{rd} party OEM. The sensor devices, the I3C master 331, and the isolation device 335 may be coupled by a two-wire bidirectional serial bus including a wire 351 designated as serial data (SDA) and a wire 353 designated as serial clock (SCL).

In embodiments, the one or more sensor devices, e.g., the sensor device 341, the sensor device 343, the sensor device 345, or the sensor device 347, may include a motion sensor, a biometric sensor, an environmental sensor for temperature or ambient light measurement, a radar sensor, an ultrasonic sensor, a video sensor, a camera sensor, a light detection and ranging (LiDAR) sensor, a gyro sensor, a fingerprint sensor, a carbon monoxide sensor, a heart rate monitor, a global positioning system (GPS), an Internet of Things (IoT) device, a general purpose input/output (GPIO) device, or other devices.

In embodiments, the I3C network tester 301 may be coupled to the host 305 by the interface circuitry 311, which may be a sideband router between the host 305 and the I3C network tester 301. The I3C network tester 301 may be coupled to the I3C network 303 by the interface circuitry 318, which may be a sideband network component. The I3C network tester 301 may be coupled directly to the two-wire bidirectional serial bus including the wire 351 and the wire 353. The I3C network 303 may be coupled to the host 305 by various routers and bridges, e.g., a primary fabric 317, a SoC fabric bridge 315, and a high speed fabric 313.

FIG. 3(b) illustrates an example process 350 by the I3C network tester 301 to test the I3C master 331 included in the I3C network 303. FIG. 3(c) illustrates an example process 360 by the I3C network tester 301 to test a (slave) sensor device included in the I3C network 303.

As shown in FIG. 3(b), the process 350 may start at an interaction 351. During the interaction 351, the host 305 is to determine a set of protocols to be tested for selected ones of the I3C master 331 and the one or more sensor devices of the I3C network 303. The set of protocols may be stored in the system memory 306 of the host 305. The set of protocols may be loaded into the system memory 306 from a flash memory by BIOS of the host 305. The CPU 307 may access the system memory 306 for the set of protocols and select the I3C master 331 to be tested.

During an interaction 352, the host 305 may transmit to the I3C network tester 301 the identification of the selected I3C master 331 to be tested for the set of protocols. In some embodiments, the identifications of the selected ones of the I3C master 331 and the one or more sensor devices may include an address of the selected ones in the I3C network 303. Furthermore, the host 305 may transmit to the I3C network tester 301 test data or instructions to generate test data to test the selected ones of the I3C master 331 and the one or more sensor devices for the set of protocols. The host 305 may generate by the CPU 307 the test data for the set of protocols and store the test data in the system memory 306. Additionally and alternatively, the CPU 307 may send the instructions to the I3C network tester 301 to generate at least some or all the test data to test the ones of the I3C master 331 and the one or more sensor devices. In embodiments, the I3C network tester 301 is to receive the test data from the host 305, or generate at least some or all the test data based on instructions received from the host 305. The I3C network tester 301 is to generate the test data by the test data generation circuitry 321.

During an interaction 353, the I3C network tester 301 is to send the test data to the I3C master 331 directly by the transmitter circuitry 323. The I3C master 331 may perform operations according to the test data received from the transmitter circuitry 323, and generate response data. The isolation device 335 is in an ON state when the I3C network tester 301 is to test the function of the I3C master 331. During an interaction 354, the I3C network tester 301 is to receive response data from the I3C master 331 by the receiver circuitry 325. During an interaction 355, the I3C network tester 301 is to evaluate the response data by the analysis circuitry 327 to determine a test result to indicate whether the I3C master 331 is in a faulty state with respect to the function to be tested, e.g., for a set of protocols of the I3C network. During an interaction 356, the I3C network tester 301 is to store the test result in the storage 329, where the storage 329 is accessible by the host 305. During an interaction 357, the I3C network tester 301 is to send the test result, and the host 305 is to receive the test result including indications of whether the I3C master 331 is in a faulty state. Additionally and alternatively, the I3C network tester 301 may communicate the test result to the host 305 through the interface circuitry 311 without saving the test result in the storage 329.

In addition, the host 305 may perform other operations not shown in FIG. 3(b). For example, the host 305 is further to determine an action to be applied to the selected I3C master 331 indicated as being in the faulty state with respect to the set of protocols.

FIG. 3(c) illustrates an example process 360 by the I3C network tester 301 to test a (slave) sensor device, e.g., the sensor device 343, included in the I3C network 303.

As shown in FIG. 3(c), the process 360 may start at an interaction 361. During the interaction 361, the host 305 is to determine a set of protocols to be tested for selected ones of the I3C master 331 and the one or more sensor devices of the I3C network 303, e.g., the sensor device 343. The set of protocols may be stored in the system memory 306 of the host 305. The set of protocols may be loaded into the system memory 306 from a flash memory by BIOS of the host 305. The CPU 307 may access the system memory 306 for the set of protocols and select the sensor device 343 to be tested.

During an interaction 362, the host 305 may transmit to the I3C network tester 301 the identification of the selected sensor device 343 to be tested for the set of protocols. In some embodiments, the identifications of the selected sensor device 343 may include an address of the selected sensor device 343 in the I3C network 303. Furthermore, the host 305 may transmit to the I3C network tester 301 test data or instructions to generate test data to test the selected sensor device 343 for the set of protocols. The host 305 may generate by the CPU 307 the test data for the set of protocols and store the test data in the system memory 306. Additionally and alternatively, the CPU 307 may send the instructions to the I3C network tester 301 to generate the test data to test the selected sensor device 343. The I3C network tester 301 is to receive the test data from the host 305, or generate the test data based on instructions received from the host 305. In detail, the I3C network tester 301 is to generate the test data by the test data generation circuitry 321.

During an interaction 363, the I3C network tester 301 is to configure the I3C master 331 to operate in a slave mode, and further send the test data to the I3C master 331 by the transmitter circuitry 323. During an interaction 364, the test data is further sent from the I3C master 331 to the selected sensor device 343. The selected sensor device 343 may perform operations according to the test data received from the I3C master 331, and generate response data to the test data. During an interaction 365, the selected sensor device 343 is to send the response data to the I3C master 331. During an interaction 366, the receiver circuitry 125 of the I3C network tester 301 is to receive the response data from the I3C master 331.

During an interaction 367, the I3C network tester 301 is to evaluate the response data by the analysis circuitry 327 to determine a test result to indicate whether the sensor device 343 is in a faulty state with respect to the function to be tested, e.g., for a set of protocols of the I3C network. During an interaction 368, the I3C network tester 301 is to store the test result in the storage 329, where the storage 329 is accessible by the host 305. During an interaction 369, the I3C network tester 301 is to send the test result, and the host 305 is to receive the test result including indications of whether the sensor device 343 is in a faulty state. In addition, the host 305 may perform other operations not shown in FIG. 3(c). For example, the host 305 is further to determine an action to be applied to the selected sensor device 343 indicated as being in the faulty state with respect to the set of protocols.

In embodiments, the I3C network tester 301 or the I3C network 303 may operate in various speed, e.g., single data rate (SDR), high data rate (HDR), as specified by the standard of I3C network. In more detail, the I3C network tester 301 or the I3C network 303 may is to operate in a data rate of 10 Mbps, or a data rate of 26.7 Mbps.

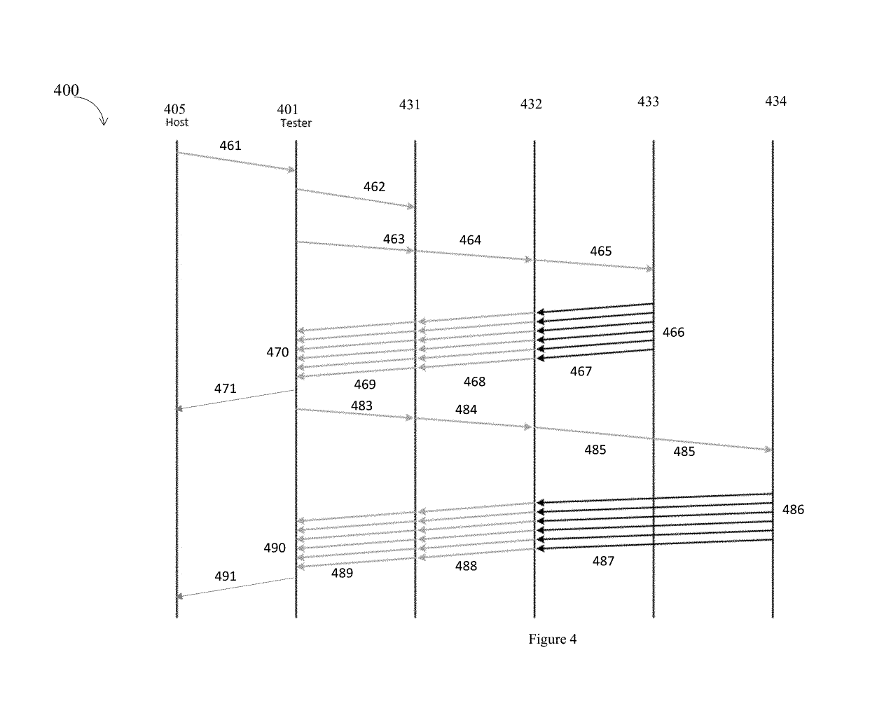

FIG. 4 illustrates a sequence diagram of a process 400 performed by an I3C network tester 401 coupled to an I3C master 431 and a host 405 to test one or more sensor devices, e.g., a sensor device 433, or a sensor device 434, included in an I3C network, in accordance with various embodiments. In embodiments, the I3C network tester 401, the I3C master 431, the host 405, the sensor device 433, or the sensor device 434 may be examples of the I3C network tester 301, the I3C master 331, the host 305, the sensor device 341, the sensor device 343, the sensor device 345, or the sensor device 347, respectively, as shown in FIGS. 3(a)-3(c).

The process 400 may start at an interaction 461. During the interaction 461, the host 405 is to determine a set of protocols to be tested for the sensor device 433, and transmit to the I3C network tester 401 the identification of the sensor device 433 to be tested for the set of protocols. Furthermore, the host 405 may transmit to the I3C network tester 401 test data or instructions to generate test data to test the sensor device 433 for the set of protocols. In embodiments, the I3C network tester 401 is to receive the test data from the host 405, or generate the test data based on instructions received from the host 405. During an interaction 462, the I3C network tester 401 is to configure the I3C master 431 to operate in a slave mode.

During an interaction 463, the I3C network tester 401 is to send the test data to the I3C master 431. During an interaction 464, the test data is further sent from the I3C master 431 to a computer bus 432 within the I3C network. During an interaction 465, the test data is sent from the computer bus 432 to the sensor device 433. During an interaction 466, the sensor device 433 may perform operations according to the test data received from the I3C master 431, and generate response data to the test data. During an interaction 467, the response data may be sent from the sensor device 433 to the computer bus 432. During an interaction 468, the response data may be sent from the computer bus 432 to the I3C master 431. During an interaction 469, the response data may be sent from the I3C master 431 to the I3C network tester 401. During an interaction 470, the I3C network tester 401 is to evaluate the response data to determine a test result to indicate whether the sensor device 433 is in a faulty state with respect to the function to be tested, e.g., for a set of protocols of the I3C network. During an interaction 471, the I3C network tester 401 is to send the test result to the host 405, and the host 405 is to receive the test result including indications of whether the sensor device 433 is in a faulty state. In addition, the host 305 may perform other operations not shown in FIG. 4. For example, the host 405 is further to determine an action to be applied to the selected sensor device 433 indicated as being in the faulty state with respect to the set of protocols.

Multiple sensor devices may be tested in similar ways. For example, the sensor device 434 may be tested in a similar fashion as the testing for the sensor device 433. During an interaction 483, the I3C network tester 401 is to send the test data to the I3C master 431. During an interaction 484, the test data is further sent from the I3C master 431 to the computer bus 432 within the I3C network. During an interaction 485, the test data is sent from the computer bus 432 to the sensor device 434. During an interaction 486, the sensor device 434 may perform operations according to the test data received from the I3C master 431, and generate response data to the test data. During an interaction 487, the response data may be sent from the sensor device 434 to the computer bus 432. During an interaction 488, the response data may be sent from the computer bus 432 to the I3C master 431. During an interaction 489, the response data may be sent from the I3C master 431 to the I3C network tester 401. During an interaction 490, the I3C network tester 401 is to evaluate the response data to determine a test result to indicate whether the sensor device 434 is in a faulty state with respect to the function to be tested, e.g., for a set of protocols of the I3C network. During an interaction 491, the I3C network tester 401 is to send the test result to the host 405, and the host 405 is to receive the test result including indications of whether the sensor device 434 is in a faulty state.

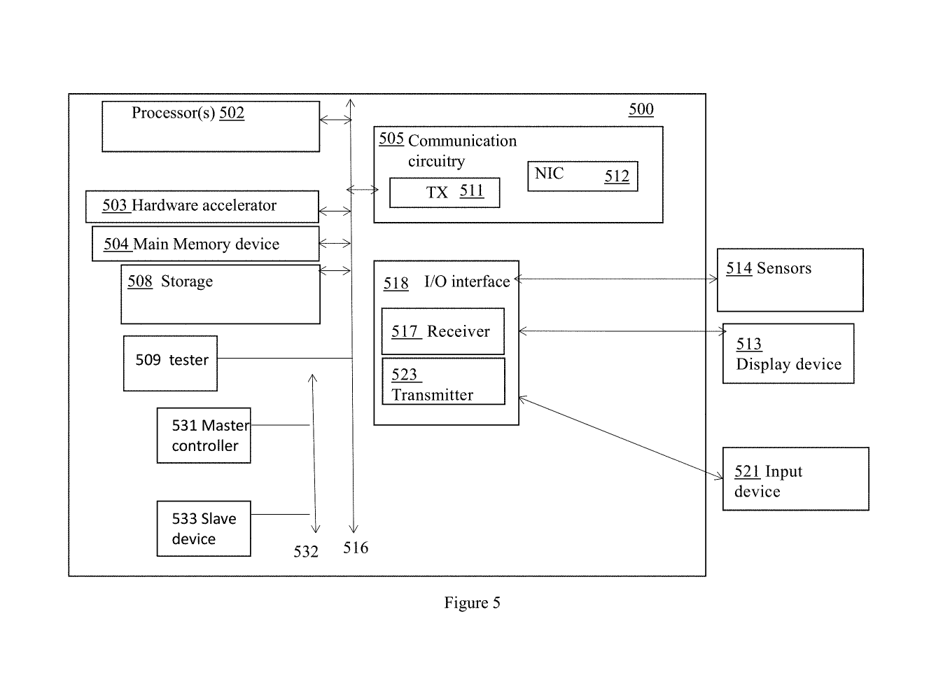

FIG. 5 illustrates an example device 500 suitable for use to practice various aspects of the present disclosure, in accordance with various embodiments. The device 500 may be used to implement functions of the computing system 100, the computing system 200, the computing system 300, or the computing system to perform the process 400.

As shown, the device 500 may include one or more processors 502, each having one or more processor cores, or and optionally, a hardware accelerator 503 (which may be an ASIC or a FPGA). In alternate embodiments, the hardware accelerator 503 may be part of processor 502, or integrated together on a SOC. Additionally, the device 500 may include a main memory device 504, which may be any one of a number of known persistent storage medium, and a data storage circuitry 508. In addition, the 500 may include an I/O interface circuitry 518 having a transmitter 523 and a receiver 517, and coupled to one or more sensors 514, a display device 513, and an input device 521. Furthermore, the device 500 may include communication circuitry 505 including a transceiver (Tx) 511, and network interface controller (NIC) 512. The elements may be coupled to each other via system bus 516, which may represent one or more buses. In the case of multiple buses, they may be bridged by one or more bus bridges (not shown).

In addition, the device 500 may include a tester 509 coupled to the system bus 516, which is further coupled to the processor 502. The device 500 may further include a master controller 531 and a slave device 533 coupled to a computer bus 532. There may be more slave devices coupled to the computer bus 532. In embodiments, the tester 509, the processor 502, the master controller 531, the slave device 533, the one or more sensors 514, the display device 513, or the input device 521, may be examples of the tester 101, the host 105, the master device 131, or the slave device 133 in FIG. 1, the tester 201, the host 205, the master controller 231, or the slave device 233 in FIG. 2, the I3C network tester 301, the host 305, the I3C master 331, or the sensor device 341 in FIGS. 3(a)-3(c), the I3C network tester 401, the host 405, the I3C master 431, or the sensor device 433 in FIG. 4.

In embodiments, the processor(s) 502 (also referred to as “processor circuitry 502”) may be one or more processing elements configured to perform basic arithmetical, logical, and input/output operations by carrying out instructions. Processor circuitry 502 may be implemented as a standalone system/device/package or as part of an existing system/device/package. The processor circuitry 502 may be one or more microprocessors, one or more single-core processors, one or more multi-core processors, one or more multithreaded processors, one or more GPUs, one or more ultra-low voltage processors, one or more embedded processors, one or more DSPs, one or more FPDs (hardware accelerators) such as FPGAs, structured ASICs, programmable SoCs (PSoCs), etc., and/or other processor or processing/controlling circuit. The processor circuitry 502 may be a part of a SoC in which the processor circuitry 502 and other components discussed herein are formed into a single IC or a single package. As examples, the processor circuitry 502 may include one or more Intel Pentium®, Core®, Xeon®, Atom®, or Core M® processor(s); Advanced Micro Devices (AMD) Accelerated Processing Units (APUs), Epyc®, or Ryzen® processors; Apple Inc. A series, S series, W series, etc. processor(s); Qualcomm Snapdragon® processor(s); Samsung Exynos® processor(s); and/or the like.

In embodiments, the I/O interface circuitry 518 may include a sensor hub, which may act as a coprocessor by processing data obtained from the one or more sensors 514. The sensor hub may include circuitry configured to integrate data obtained from each of the one or more sensors 514 by performing arithmetical, logical, and input/output operations. In embodiments, the sensor hub may capable of timestamping obtained sensor data, providing sensor data to the processor circuitry 502 in response to a query for such data, buffering sensor data, continuously streaming sensor data to the processor circuitry 502 including independent streams for each sensor of the one or more sensors 514, reporting sensor data based upon predefined thresholds or conditions/triggers, and/or other like data processing functions.

In embodiments, the memory 504 (also referred to as “memory circuitry 504” or the like) may be circuitry configured to store data or logic for operating the computer device 500. The memory circuitry 504 may include number of memory devices may be used to provide for a given amount of system memory. As examples, the memory circuitry 504 can be any suitable type, number and/or combination of volatile memory devices (e.g., random access memory (RAM), dynamic RAM (DRAM), static RAM (SAM), etc.) and/or non-volatile memory devices (e.g., read-only memory (ROM), erasable programmable read-only memory (EPROM), electrically erasable programmable read-only memory (EEPROM), flash memory, antifuses, etc.) that may be configured in any suitable implementation as are known. In various implementations, individual memory devices may be formed of any number of different package types, such as single die package (SDP), dual die package (DDP) or quad die package (Q17P), dual inline memory modules (DIMMs) such as microDIMMs or MiniDIMMs, and/or any other like memory devices. To provide for persistent storage of information such as data, applications, operating systems and so forth, the memory circuitry 504 may include one or more mass-storage devices, such as a solid state disk drive (SSDD); flash memory cards, such as SD cards, microSD cards, xD picture cards, and the like, and USB flash drives; on-die memory or registers associated with the processor circuitry 502 (for example, in low power implementations); a micro hard disk drive (HDD); three dimensional cross-point (3D XPOINT) memories from Intel® and Micron®, etc.

Where FPDs are used, the processor circuitry 502 and memory circuitry 504 (and/or data storage circuitry 508) may comprise logic blocks or logic fabric, memory cells, input/output (I/O) blocks, and other interconnected resources that may be programmed to perform various functions of the example embodiments discussed herein. The memory cells may be used to store data in lookup-tables (LUTs) that are used by the processor circuitry 502 to implement various logic functions. The memory cells may include any combination of various levels of memory/storage including, but not limited to, EPROM, EEPROM, flash memory, SRAM, anti-fuses, etc.

In embodiments, the data storage circuitry 508 (also referred to as “storage circuitry 508” or the like), with shared or respective controllers, may provide for persistent storage of information, operating systems, etc. The data storage circuitry 508 may be implemented as solid state drives (SSDs); solid state disk drive (SSDD); serial AT attachment (SATA) storage devices (e.g., SATA SSDs); flash drives; flash memory cards, such as SD cards, microSD cards, xD picture cards, and the like, and USB flash drives; three-dimensional cross-point (3D Xpoint) memory devices; on-die memory or registers associated with the processor circuitry 502; hard disk drives (HDDs); micro HDDs; resistance change memories; phase change memories; holographic memories; or chemical memories; among others. As shown, the data storage circuitry 508 is included in the computer device 500; however, in other embodiments, the data storage circuitry 508 may be implemented as one or more devices separated from the other elements of computer device 500.

In some embodiments, the data storage circuitry 508 may include an operating system (OS) (not shown), which may be a general purpose operating system or an operating system specifically written for and tailored to the computer device 500. The OS may include one or more drivers, libraries, and/or application programming interfaces (APIs), which provide program code and/or software components, and/or control system configurations to control and/or obtain/process data from the one or more sensors 514.

The components of computer device 500 may communicate with one another over the bus 516. The bus 516 may include any number of technologies, such as a Local Interconnect Network (LIN); industry standard architecture (ISA); extended ISA (EISA); PCI; PCI extended (PCIx); PCIe; an Inter-Integrated Circuit (I2C) bus; a Parallel Small Computer System Interface (SPI) bus; Common Application Programming Interface (CAPI); point to point interfaces; a power bus; a proprietary bus, for example, Intel® Ultra Path Interface (UPI), Intel® Accelerator Link (IAL), or some other proprietary bus used in a SoC based interface; or any number of other technologies. In some embodiments, the bus 516 may be a controller area network (CAN) bus system, a Time-Trigger Protocol (TTP) system, or a FlexRay system, which may allow various devices (e.g., the one or more sensors 514, etc.) to communicate with one another using messages or frames.

The communications circuitry 505 may include circuitry for communicating with a wireless network or wired network. For example, the communication circuitry 505 may include transceiver (Tx) 511 and network interface controller (NIC) 512. Communications circuitry 505 may include one or more processors (e.g., baseband processors, modems, etc.) that are dedicated to a particular wireless communication protocol.

NIC 512 may be included to provide a wired communication link to a network and/or other devices. The wired communication may provide an Ethernet connection, an Ethernet-over-USB, and/or the like, or may be based on other types of networks, such as DeviceNet, ControlNet, Data Highway+, PROFIBUS, or PROFINET, among many others. An additional NIC 512 may be included to allow connect to a second network (not shown) or other devices, for example, a first NIC 512 providing communications to the network 150 over Ethernet, and a second NIC 512 providing communications to other devices over another type of network, such as a personal area network (PAN) including a personal computer (PC) device. In some embodiments, the various components of the device 500, such as the one or more sensors 514, etc. may be connected to the processor(s) 502 via the NIC 512 as discussed above rather than via the I/O interface circuitry 518 as discussed infra.

The Tx 511 may include one or more radios to wirelessly communicate with a network and/or other devices. The Tx 511 may include hardware devices that enable communication with wired networks and/or other devices using modulated electromagnetic radiation through a solid or non-solid medium. Such hardware devices may include switches, filters, amplifiers, antenna elements, and the like to facilitate the communications over the air (OTA) by generating or otherwise producing radio waves to transmit data to one or more other devices, and converting received signals into usable information, such as digital data, which may be provided to one or more other components of computer device 500. In some embodiments, the various components of the device 500, such as the one or more sensors 514, etc. may be connected to the device 500 via the Tx 511 as discussed above rather than via the I/O interface circuitry 518 as discussed infra. In one example, the one or more sensors 514 may be coupled with device 500 via a short range communication protocol.

The Tx511 may include one or multiple radios that are compatible with any number of 3GPP (Third Generation Partnership Project) specifications, notably Long Term Evolution (LTE), Long Term Evolution-Advanced (LTE-A), Long Term Evolution-Advanced Pro (LTE-A Pro), and Fifth Generation (5G) New Radio (NR). It can be noted that radios compatible with any number of other fixed, mobile, or satellite communication technologies and standards may be selected. These may include, for example, any Cellular Wide Area radio communication technology, which may include e.g. a 5G communication systems, a Global System for Mobile Communications (GSM) radio communication technology, a General Packet Radio Service (GPRS) radio communication technology, or an Enhanced Data Rates for GSM Evolution (EDGE) radio communication technology. Other Third Generation Partnership Project (3GPP) radio communication technology that may be used includes UMTS (Universal Mobile Telecommunications System), FOMA (Freedom of Multimedia Access), 3GPP LTE (Long Term Evolution), 3GPP LTE Advanced (Long Term Evolution Advanced), 3GPP LTE Advanced Pro (Long Term Evolution Advanced Pro)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-SCDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11 ay, and the like. In addition to the standards listed above, any number of satellite uplink technologies may be used for the uplink transceiver, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated. Implementations, components, and details of the aforementioned protocols may be those known in the art and are omitted herein for the sake of brevity.

The input/output (I/O) interface circuitry 518 may include circuitry, such as an external expansion bus (e.g., Universal Serial Bus (USB), FireWire, Thunderbolt, PCI/PCIe/PCIx, etc.), used to connect computer device 500 with external components/devices, such as one or more sensors 514, etc. I/O interface circuitry 518 may include any suitable interface controllers and connectors to interconnect one or more of the processor circuitry 502, memory circuitry 504, data storage circuitry 508, communication circuitry 505, and the other components of computer device 500. The interface controllers may include, but are not limited to, memory controllers, storage controllers (e.g., redundant array of independent disk (RAID) controllers, baseboard management controllers (BMCs), input/output controllers, host controllers, etc. The connectors may include, for example, busses (e.g., bus 516), ports, slots, jumpers, interconnect modules, receptacles, modular connectors, etc. The I/O interface circuitry 518 may couple the device 500 with the one or more sensors 514, etc. via a wired connection, such as using USB, FireWire, Thunderbolt, RCA, a video graphics array (VGA), a digital visual interface (DVI) and/or mini-DVI, a high-definition multimedia interface (HDMI), an S-Video, and/or the like.

The one or more sensors 514 may be any device configured to detect events or environmental changes, convert the detected events into electrical signals and/or digital data, and transmit/send the signals/data to the computer device 500. Some of the one or more sensors 514 may be sensors used for providing computer-generated sensory inputs. Some of the one or more sensors 514 may be sensors used for motion and/or object detection. Examples of such one or more sensors 514 may include, inter alia, charged-coupled devices (CCD), Complementary metal-oxide-semiconductor (CMOS) active pixel sensors (APS), lens-less image capture devices/cameras, thermographic (infrared) cameras, Light Imaging Detection And Ranging (LIDAR) systems, and/or the like. In some implementations, the one or more sensors 514 may include a lens-less image capture mechanism comprising an array of aperture elements, wherein light passing through the array of aperture elements define the pixels of an image. In embodiments, the motion detection one or more sensors 514 may be coupled with or associated with light generating devices, for example, one or more infrared projectors to project a grid of infrared light onto a scene, where an infrared camera may record reflected infrared light to compute depth information.

Some of the one or more sensors 514 may be used for position and/or orientation detection, ambient/environmental condition detection, and the like. Examples of such one or more sensors 514 may include, inter alia, microelectromechanical systems (MEMS) with piezoelectric, piezoresistive and/or capacitive components, which may be used to determine environmental conditions or location information related to the computer device 500. In embodiments, the MEMS may include 3-axis accelerometers, 3-axis gyroscopes, and/or magnetometers. In some embodiments, the one or more sensors 514 may also include one or more gravimeters, altimeters, barometers, proximity sensors (e.g., infrared radiation detector(s) and the like), depth sensors, ambient light sensors, thermal sensors (thermometers), ultrasonic transceivers, and/or the like.

Each of these elements, e.g., one or more processors 502, the hardware accelerator 503, the memory 504, the data storage circuitry 508, the input/output interface circuitry 518, the one or more sensors 514, the communication circuitry 505 including the Tx 511, and the NIC 512, and the system bus 516 may perform its conventional functions known in the art. In addition, they may be employed to store and host execution of programming instructions (e.g., via storage 508, main memory device 504 and processor(s) 502) implementing the operations associated with an operating system, and one or more applications, e.g., a neural network of an artificial intelligence applications. The operation system and/or applications may be implemented by assembler instructions supported by processor(s) 502 or high-level languages, such as, for example, C, that can be compiled into such instructions. Operations associated with the device 500 not implemented in software may be implemented in hardware, e.g., via hardware accelerator 503.

The number, capability and/or capacity of these elements 502-533 may vary, depending on the number of other devices the device 500 is configured to support. Otherwise, the constitutions of elements 502-533 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.”

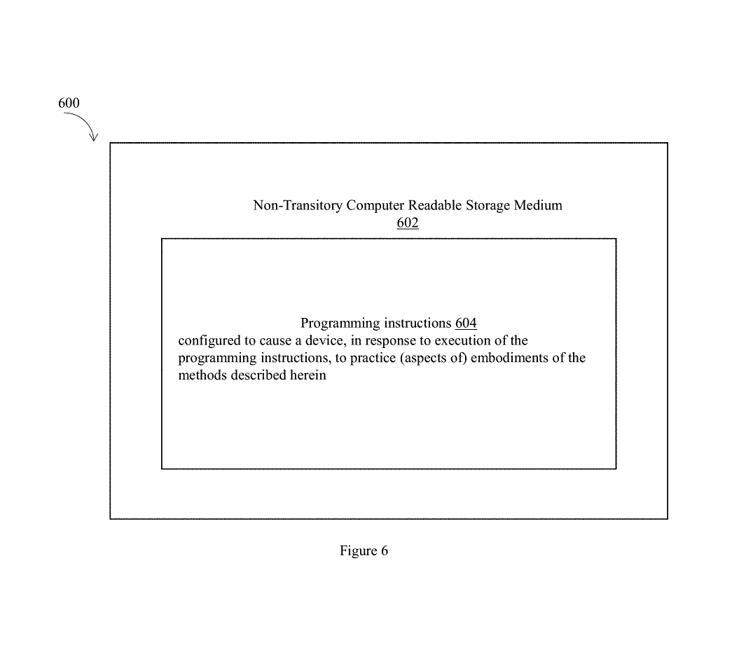

Furthermore, the present disclosure may take the form of a computer program product embodied in any tangible or non-transitory medium of expression having computer-usable program code embodied in the medium. FIG. 6 illustrates an example computer-readable non-transitory storage medium that may be suitable for use to store instructions that cause an apparatus or a computing device, in response to execution of the instructions by the apparatus or the computing device, to practice selected aspects of the present disclosure. As shown, non-transitory computer-readable storage medium 602 may include a number of programming instructions 604. Programming instructions 604 may be configured to enable components of a device, e.g., for device 500, in particular, processor(s) 502 and/or tester 509, in response to execution of the programming instructions, to perform, e.g., various operations associated with a tester, e.g., an I3C network tester, coupled to a master-slave device network and a host to test a master-slave device network, such as, a selected device of a master device, e.g., an I3C master, or a slave device, as shown in FIGS. 1-5.

In alternate embodiments, programming instructions 604 may be disposed on multiple computer-readable non-transitory storage media 602 instead. In alternate embodiments, programming instructions 604 may be disposed on computer-readable transitory storage media 602, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment are chosen and described in order to best explain the principles of the disclosure and the practical application, and to enable others of ordinary skill in the art to understand the disclosure for embodiments with various modifications as are suited to the particular use contemplated.

### EXAMPLES

Example 1 may include an apparatus for testing, comprising: a programmable tester coupled to a master-slave device network having a master device and at least one slave device, including: interface circuitry to receive a configuration mode from a host to test a function of a selected device of the master device or the at least one slave device of the master-slave device network, wherein the configuration mode is to indicate that the programmable tester is to be configured to operate in a slave mode or in a master mode; and logic circuitry to configure the programmable tester according to the configuration mode on receipt of the configuration mode; send test data to test the function of the selected device, determine a test result based on response data by the selected device to the test data, and indicate whether the selected device is in a faulty state with respect to the function based at least in part on the test result.

Example 2 may include the apparatus of example 1 and/or some other examples herein, wherein the logic circuitry is to indicate to the host whether the selected device is in the faulty state with respect to the function, via the interface circuitry.

Example 3 may include the apparatus of example 1 and/or some other examples herein, wherein the logic circuitry includes test data generation circuitry to generate at least a portion of the test data being sent to test the function of the selected device.

Example 4 may include the apparatus of example 1 and/or some other examples herein, wherein when the programmable tester is configured to operate in slave mode according to the configuration mode, the selected device is the master device, and the logic circuitry includes: transmitter circuitry to send the test data to the selected master device; receiver circuitry to receive response data from the selected master device in response to the test data; and analysis circuitry to evaluate the response data to determine the test result.

Example 5 may include the apparatus of example 1 and/or some other examples herein, wherein when the programmable tester is configured to operate in master mode according to the configuration mode, the selected device is a slave device, and the logic circuitry includes: transmitter circuitry to send the test data to the selected slave device through the master device of the master-slave device network; receiver circuitry to receive through the master device the response data from the selected slave device in response to the test data; and analysis circuitry to evaluate the response data to determine the test result.

Example 6 may include the apparatus of example 5 and/or some other examples herein, wherein the transmitter circuitry is to send the test data to the selected slave device of the master-slave device network by broadcasting.

Example 7 may include the apparatus of example 5 and/or some other examples herein, wherein the transmitter circuitry is to send the test data to the selected slave device with an address of the selected slave device, and track the test data sent to the selected slave device.

Example 8 may include the apparatus of example 5 and/or some other examples herein, wherein the logic circuitry is to further configure the master device of the master-slave device network to operate in a slave mode, for the receiver circuitry to receive the response data through the master device.

Example 9 may include the apparatus of example 5 and/or some other examples herein, wherein the logic circuitry is further to disable the selected slave device when the test result indicates the selected slave device is in the faulty state with respect to the function.

Example 10 may include an apparatus for computing, comprising: a master-slave device network including a master controller and a computer bus to couple the master controller to one or more slave devices; and a tester coupled to the master-slave device network to test a function of a selected one of the master controller or the one or more slave devices, the tester to: send test data to the master controller directly when the function being tested is of the master controller, and send test data to the one slave device, via the master controller, when the function being tested is of the one slave device; receive response data from the master controller or the one slave device in response to the test data; and evaluate the response data to determine a test result to indicate whether the master controller or the one slave device is in a faulty state with respect to the function.

Example 11 may include the apparatus of example 10 and/or some other examples herein, wherein the function of the device includes a function of the device to act as the master controller, a function of the device to act as a slave device for the master controller, arbitration between two slave devices coupled to the master controller, an operating frequency of the device of the master-slave device network, a traffic pattern of the device, or a short or an open of the computer bus coupling the master controller to one or more slave devices.

Example 12 may include the apparatus of example 10 and/or some other examples herein, wherein when the tester is configurable as either to operate in a slave mode or in a master mode.

Example 13 may include the apparatus of example 10 and/or some other examples herein, wherein the apparatus is a system-on-chip (SoC) having the master-slave device network, the master controller, and the tester.

Example 14 may include the apparatus of example 10 and/or some other examples herein, wherein the computer bus to couple the master controller to the one or more slave devices includes a two-wire bidirectional serial bus controlled by the master controller.

Example 15 may include the apparatus of example 14 and/or some other examples herein, wherein the two-wire bidirectional serial bus includes a wire designated as serial data (SDA) and a wire designated as serial clock (SCL).

Example 16 may include the apparatus of example 10 and/or some other examples herein, wherein the master-slave device network further includes an isolation device to isolate the computer bus to prevent noise from the computer bus, and the isolation device is in an ON state when the tester is configured to operate in a slave mode to test the function of the master controller.

Example 17 may include the apparatus of example 10 and/or some other examples herein, further comprising: a storage coupled to the tester to store the test result, wherein the storage is accessible by a host.

Example 18 may include the apparatus of example 10 and/or some other examples herein, wherein the master-slave device network is an I3C network, and the tester is to operate in a data rate of 10 Mbps, or a data rate of 26.7 Mbps.

Example 19 may include an apparatus for computing, comprising: an I3C network including an I3C master and a 2-wire bus to couple the I3C master to one or more sensor devices; an I3C network tester coupled to the I3C network; and a processor coupled to the I3C network and the I3C network tester, the processor to: determine selected ones of the I3C master and the one or more sensor devices to be tested for a set of protocols of the I3C network; transmit to the I3C network tester identifications of the selected ones of the I3C master and the one or more sensor devices to be tested for the set of protocols; transmit to the I3C network tester test data or instructions to generate test data to test the selected ones of the I3C master and the one or more sensor devices for the set of protocols; and receive indications from the I3C network tester on whether one or more of the selected the ones of the I3C master and the one or more sensor devices are in a faulty state with respect to the set of protocols.

Example 20 may include the apparatus of example 19 and/or some other examples herein, further comprising a system-on-chip (SOC) having the I3C network, the processor, the I3C tester, and a storage to store the indications of whether one or more of the selected the ones of the I3C master and the one or more sensor devices are in the faulty state with respect to the set of protocols; wherein the processor is to receive the indication by accessing the storage.

Example 21 may include the apparatus of example 19 and/or some other examples herein, wherein the processor is to further determine an action to be applied to one of the selected the ones of the I3C master and the one or more sensor devices indicated as being in the faulty state with respect to the set of protocols.

Example 22 may include the apparatus of example 19 and/or some other examples herein, wherein the one or more sensor devices include a motion sensor, a biometric sensor, an environmental sensor for temperature or ambient light measurement, a radar sensor, an ultrasonic sensor, a video sensor, a camera sensor, a light detection and ranging (LiDAR) sensor, a gyro sensor, a fingerprint sensor, a carbon monoxide sensor, a heart rate monitor, a global positioning system (GPS), or an Internet of Things (IoT) device.

Example 23 may include the apparatus of example 19 and/or some other examples herein, wherein the set of protocols includes a function of the device to act as the I3C master, a function of the device to act as a slave device for the I3C master, arbitration between two slave devices coupled to the I3C master, an operating frequency of the device of I3C network, a traffic pattern of the device, or a short or an open of the 2-wire bus coupling the I3C master to one or more slave devices.

Example 24 may include the apparatus of example 19 and/or some other examples herein, wherein the I3C network tester is to operate in a data rate of 10 Mbps, or a data rate of 26.7 Mbps.

Example 25 may include the apparatus of example 19 and/or some other examples herein, wherein the I3C network tester is to disable the selected one or more sensor devices when the test result indicates the selected the ones of the I3C master and the one or more sensor devices are in the faulty state with respect to the set of protocols.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. An apparatus for testing, comprising:
a programmable tester coupled to a master-slave device network having a master device and at least one slave device, including:
interface circuitry to receive a configuration mode from a host to test a function of a selected device of the master device or the at least one slave device of the master-slave device network, wherein the configuration mode is to indicate that the programmable tester is to be configured to operate in a slave mode or in a master mode; and
logic circuitry to
configure the programmable tester according to the configuration mode on receipt of the configuration mode;
send test data to test the function of the selected device,
determine a test result based on response data by the selected device to the test data, and
indicate whether the selected device is in a faulty state with respect to the function based at least in part on the test result.

2. The apparatus of claim 1, wherein the logic circuitry is to indicate to the host whether the selected device is in the faulty state with respect to the function, via the interface circuitry.

3. The apparatus of claim 1, wherein the logic circuitry includes test data generation circuitry to generate at least a portion of the test data being sent to test the function of the selected device.

4. The apparatus of claim 1, wherein when the programmable tester is configured to operate in slave mode according to the configuration mode, the selected device is the master device, and the logic circuitry includes:
transmitter circuitry to send the test data to the selected master device;
receiver circuitry to receive response data from the selected master device in response to the test data; and
analysis circuitry to evaluate the response data to determine the test result.

5. The apparatus of claim 1, wherein when the programmable tester is configured to operate in master mode according to the configuration mode, the selected device is a slave device, and the logic circuitry includes:
transmitter circuitry to send the test data to the selected slave device through the master device of the master-slave device network;
receiver circuitry to receive through the master device the response data from the selected slave device in response to the test data; and
analysis circuitry to evaluate the response data to determine the test result.

6. The apparatus of claim 5, wherein the transmitter circuitry is to send the test data to the selected slave device of the master-slave device network by broadcasting.

7. The apparatus of claim 5, wherein the transmitter circuitry is to send the test data to the selected slave device with an address of the selected slave device, and track the test data sent to the selected slave device.

8. The apparatus of claim 5, wherein the logic circuitry is to further configure the master device of the master-slave device network to operate in a slave mode, for the receiver circuitry to receive the response data through the master device.

9. The apparatus of claim 5, wherein the logic circuitry is further to disable the selected slave device when the test result indicates the selected slave device is in the faulty state with respect to the function.

10. An apparatus for computing, comprising:
a master-slave device network including a master controller and a computer bus to couple the master controller to one or more slave devices; and
a tester coupled to the master-slave device network to test a function of a selected one of the master controller or the one or more slave devices, the tester to:
send test data to the master controller directly when the function being tested is of the master controller, and send test data to the one slave device, via the master controller, when the function being tested is of the one slave device;
receive response data from the master controller or the one slave device in response to the test data; and
evaluate the response data to determine a test result to indicate whether the master controller or the one slave device is in a faulty state with respect to the function.

11. The apparatus of claim 10, wherein the function of the device includes a function of the device to act as the master controller, a function of the device to act as a slave device for the master controller, arbitration between two slave devices coupled to the master controller, an operating frequency of the device of the master-slave device network, a traffic pattern of the device, or a short or an open of the computer bus coupling the master controller to one or more slave devices.

12. The apparatus of claim 10, wherein when the tester is configurable as either to operate in a slave mode or in a master mode.

13. The apparatus of claim 10, wherein the apparatus is a system-on-chip (SoC) having the master-slave device network, the master controller, and the tester.

14. The apparatus of claim 10, wherein the computer bus to couple the master controller to the one or more slave devices includes a two-wire bidirectional serial bus controlled by the master controller.

15. The apparatus of claim 14, wherein the two-wire bidirectional serial bus includes a wire designated as serial data (SDA) and a wire designated as serial clock (SCL).

16. The apparatus of claim 10, wherein the master-slave device network further includes an isolation device to isolate the computer bus to prevent noise from the computer bus, and the isolation device is in an ON state when the tester is configured to operate in a slave mode to test the function of the master controller.

17. The apparatus of claim 10, further comprising:
a storage coupled to the tester to store the test result, wherein the storage is accessible by a host.

18. The apparatus of claim 10, wherein the master-slave device network is an I3C network, and the tester is to operate in a data rate of 10 Mbps, or a data rate of 26.7 Mbps.

19. An apparatus for computing, comprising:
an I3C network including an I3C master and a 2-wire bus to couple the I3C master to one or more sensor devices;
an I3C network tester coupled to the I3C network; and
a processor coupled to the I3C network and the I3C network tester, the processor to:
determine selected ones of the I3C master and the one or more sensor devices to be tested for a set of protocols of the I3C network;
transmit to the I3C network tester identifications of the selected ones of the I3C master and the one or more sensor devices to be tested for the set of protocols;
transmit to the I3C network tester test data or instructions to generate test data to test the selected ones of the I3C master and the one or more sensor devices for the set of protocols; and
receive indications from the I3C network tester on whether one or more of the selected the ones of the I3C master and the one or more sensor devices are in a faulty state with respect to the set of protocols.

20. The apparatus of claim 19, further comprising a system-on-chip (SOC) having the I3C network, the processor, the I3C tester, and a storage to store the indications of whether one or more of the selected the ones of the I3C master and the one or more sensor devices are in the faulty state with respect to the set of protocols; wherein the processor is to receive the indication by accessing the storage.

21. The apparatus of claim 19, wherein the processor is to further determine an action to be applied to one of the selected the ones of the I3C master and the one or more sensor devices indicated as being in the faulty state with respect to the set of protocols.

22. The apparatus of claim 19, wherein the one or more sensor devices include a motion sensor, a biometric sensor, an environmental sensor for temperature or ambient light measurement, a radar sensor, an ultrasonic sensor, a video sensor, a camera sensor, a light detection and ranging (LiDAR) sensor, a gyro sensor, a fingerprint sensor, a carbon monoxide sensor, a heart rate monitor, a global positioning system (GPS), or an Internet of Things (IoT) device.

23. The apparatus of claim 19, wherein the set of protocols includes a function of the device to act as the I3C master, a function of the device to act as a slave device for the I3C master, arbitration between two slave devices coupled to the I3C master, an operating frequency of the device of I3C network, a traffic pattern of the device, or a short or an open of the 2-wire bus coupling the I3C master to one or more slave devices.

24. The apparatus of claim 19, wherein the I3C network tester is to operate in a data rate of 10 Mbps, or a data rate of 26.7 Mbps.

25. The apparatus of claim 19, wherein the I3C network tester is to disable the selected one or more sensor devices when the test result indicates the selected the ones of the I3C master and the one or more sensor devices are in the faulty state with respect to the set of protocols.
